(19) United States
(12) Patent Application Publication
(10) Pub. No.: US 2025/0072698 A1
(43) Pub. Date: Mar. 6, 2025

(54) System, Device, and Method for Washing Robotic Cleaners

(71) Applicant: SharkNinja Operating LLC, Needham, MA (US)

(72) Inventors: Evan Paul Jasper, Whitman, MA (US); Wendy Wang, Boston, MA (US); Jacob Marc L’Heureux, Boston, MA (US)

(21) Appl. No.: 18/819,624

(22) Filed: Aug. 29, 2024

Related U.S. Application Data
(60) Provisional application No. 63/535,354, filed on Aug. 30, 2023.

(51) Int. Cl. A47L 11/40; A47L 11/28; B05B 1/26; B05B 7/00; B08B 1/16; B08B 1/30; B08B 3/02

(52) U.S. Cl. CPC A47L 11/4091; A47L 11/28; A47L 11/4036; B05B 1/26; B05B 7/00; B08B 1/165; B08B 1/30; B08B 3/024; A47L 2201/028; B08B 2203/02

(57) ABSTRACT

Systems, devices, and methods for washing robotic cleaners are disclosed. An example robotic cleaning system may include a robotic cleaner, which may include a housing and at least one wet cleaning element including at least one cleaning surface on an underside of the housing. A docking station may include a base. A support may extend laterally from the base. The support may be configured to receive at least a portion of the robotic cleaner on top of the support. The support may define a cavity. At least one cleaning shuttle may be within the cavity and may include at least one spray nozzle and at least one mechanical contacting element. The spray nozzle(s) may be configured to spray cleaning fluid onto at least a first portion of the cleaning surface(s). The mechanical contacting element(s) may be configured to contact at least a second portion of the cleaning surface(s).

### CROSS-REFERENCE TO RELATED APPLICATION

This application claims priority to U.S. Provisional Patent Application No. 63/535,354, filed Aug. 30, 2023, the disclosure of which is hereby incorporated by reference in its entirety.

### BACKGROUND

### Field

This disclosure relates generally to automated cleaning apparatuses and, in some non-limiting embodiments or aspects, to systems, devices, and methods for washing robotic cleaners.

### Technical Considerations

Certain robotic cleaners may be equipped for wet and/or dry cleaning operations. For example, convertible robotic cleaners may be equipped to convert from operating in a wet mode (e.g., mopping) to a dry mode (e.g., vacuuming), such as through the addition or removal of components useful for a given mode. Some robotic cleaners equipped for wet cleaning operations may use a wet cleaning element (e.g., a mop pad).

However, after a cleaning operation, at least a portion of a cleaning robot may be dirty or soiled. For example, a wet cleaning element (e.g., a mop pad) of a robotic cleaner equipped for wet cleaning operations may absorb and/or be coated with debris or other material (e.g., cleaning solution, wastewater, and/or the like). If the robotic cleaner (e.g., mop pad) is not cleaned (e.g., between runs of the robotic cleaner) the effectiveness of cleaning may be reduced. Manual cleaning (e.g., by a human user) may be burdensome, cumbersome, and/or time consuming.

There is a need in the art for a technical solution to enable automatic washing of robotic cleaners (e.g., wet cleaning elements thereof, such as mop pads and/or the like).

### SUMMARY

According to some non-limiting embodiments or aspects, provided are systems, devices, and methods for washing robotic cleaners, e.g., that overcome some or all of the deficiencies identified above.

According to non-limiting embodiments or aspects, provided is a robotic cleaning system. An example robotic cleaning system may include a robotic cleaner and a docking station. The robotic cleaner may include a housing and/or at least one wet cleaning element, which may include at least one cleaning surface on an underside of the housing. The docking station may include a base and a support extending laterally from the base. The support may be configured to receive at least a portion of the robotic cleaner on top of the support. The support may define a cavity. The docking station may include at least one cleaning shuttle within the cavity. The at least one cleaning shuttle may include at least one spray nozzle and at least one mechanical contacting element. The at least one spray nozzle may be configured to spray cleaning fluid onto at least a first portion of the at least one cleaning surface. The at least one mechanical contacting element may be configured to contact at least a second portion of the at least one cleaning surface.

In some non-limiting embodiments or aspects, the at least one cleaning shuttle may be configured to move in at least one direction relative to the at least one cleaning surface while the at least one spray nozzle is spraying the cleaning fluid and the at least one mechanical contacting element is in contact with the at least one cleaning surface.

In some non-limiting embodiments or aspects, the first portion of the at least one cleaning surface may include a first strip of the at least one cleaning surface including a first length equal to a length of the at least one cleaning surface and a first width that is less than a width of the at least one cleaning surface. The second portion of the at least one cleaning surface may include a second strip of the at least one cleaning surface including a second length equal to a length of the at least one cleaning surface and a second width that is less than a width of the at least one cleaning surface. Upon movement of the at least one cleaning shuttle in the at least one direction relative to the at least one cleaning surface, the at least one spray nozzle may spray the cleaning fluid on substantially an entire surface of the at least one cleaning surface and the at least one mechanical contacting element may scrape substantially the entire surface of the at least one cleaning surface.

In some non-limiting embodiments or aspects, the at least one spray nozzle may include two spray nozzles.

In some non-limiting embodiments or aspects, the at least one spray nozzle may include at least one of a fan nozzle, a deflector nozzle, or any combination thereof.

In some non-limiting embodiments or aspects, the at least one spray nozzle may be configured to spray the cleaning fluid at a pressure of 100-300 pounds per square inch.

In some non-limiting embodiments or aspects, the at least one spray nozzle may be configured to spray the cleaning fluid at a pressure of 10-30 pounds per square inch.

In some non-limiting embodiments or aspects, the first portion of the at least one cleaning surface may include a strip of the at least one cleaning surface comprising a first length equal to a length of the at least one cleaning surface and a first width that is less than a width of the at least one cleaning surface.

In some non-limiting embodiments or aspects, the at least one mechanical contacting element may include at least one of a vertical bar, a plurality of bristles, or any combination thereof.

In some non-limiting embodiments or aspects, the at least one mechanical contacting element may include a first vertical bar and a first plurality of bristles on a first side of the at least one spray nozzle and a second vertical bar and a second plurality of bristles on a second side of the at least one spray nozzle opposite the first side.

In some non-limiting embodiments or aspects, the second portion of the at least one cleaning surface may include a strip of the at least one cleaning surface comprising a first length equal to a length of the at least one cleaning surface and a first width that is less than a width of the at least one cleaning surface.

In some non-limiting embodiments or aspects, the at least one wet cleaning element may include a plate detachably connected to the underside of the housing, and the at least one cleaning surface may include a mop pad on an underside of the plate.

In some non-limiting embodiments or aspects, the docking station may further include a cleaning fluid tank configured to store the cleaning fluid and/or a pump configured to pump the cleaning fluid from the cleaning fluid tank to the at least one spray nozzle via at least one internal cleaning fluid conduit.

In some non-limiting embodiments or aspects, the docking station may further include an accumulator fluidly coupled to the pump and configured to store the cleaning fluid under pressure and/or a valve configured to release the cleaning fluid stored under pressure in the accumulator to the at least one spray nozzle via at least one internal cleaning fluid conduit.

In some non-limiting embodiments or aspects, the docking station may further include an air compressor fluidly coupled to the accumulator and configured to increase pressure within the accumulator.

According to non-limiting embodiments or aspects, provided is a docking station for a robotic cleaner. An example docking station for a robotic cleaner may include a base and a support extending laterally from the base. The support may be configured to receive at least a portion of a robotic cleaner on top of the support. The support may define a cavity. At least one cleaning shuttle may be within the cavity and may include at least one spray nozzle and at least one mechanical contacting element. The at least one spray nozzle may be configured to spray cleaning fluid onto at least a first portion of at least one cleaning surface of at least one wet cleaning element on an underside of the robotic cleaner. The at least one mechanical contacting element may be configured to contact at least a second portion of the at least one cleaning surface.

In some non-limiting embodiments or aspects, the at least one cleaning shuttle may be configured to move in at least one direction relative to the at least one cleaning surface while the at least one spray nozzle is spraying the cleaning fluid and the at least one mechanical contacting element is in contact with the at least one cleaning surface.

In some non-limiting embodiments or aspects, the first portion of the at least one cleaning surface may include a first strip of the at least one cleaning surface including a first length equal to a length of the at least one cleaning surface and a first width that is less than a width of the at least one cleaning surface. In some non-limiting embodiments or aspects, the second portion of the at least one cleaning surface may include a second strip of the at least one cleaning surface including a second length equal to a length of the at least one cleaning surface and a second width that is less than a width of the at least one cleaning surface. Upon movement of the at least one cleaning shuttle in the at least one direction relative to the at least one cleaning surface, the at least one spray nozzle may spray the cleaning fluid on substantially an entire surface of the at least one cleaning surface and the at least one mechanical contacting element may scrape substantially the entire surface of the at least one cleaning surface.

In some non-limiting embodiments or aspects, the at least one spray nozzle my include at least one of a fan nozzle, a deflector nozzle, or any combination thereof.

In some non-limiting embodiments or aspects, the at least one mechanical contacting element may include at least one of a vertical bar, a plurality of bristles, or any combination thereof.

According to non-limiting embodiments or aspects, provided is a method. An example method may include receiving at least a portion of a robotic cleaner on top of a support extending laterally from a base of a docking station. The support may define a cavity. At least one cleaning shuttle may be moved within the cavity in at least one direction relative to at least one cleaning surface of at least one wet cleaning element on an underside of the robotic cleaner. The at least one cleaning shuttle may include at least one spray nozzle and at least one mechanical contacting element. While moving the at least one cleaning shuttle, the at least one spray nozzle may spray cleaning fluid onto at least a first portion of the at least one cleaning surface. While moving the at least one cleaning shuttle, the at least one mechanical contacting element may contact at least a second portion of the at least one cleaning surface.

Further non-limiting embodiments or aspects will be set forth in the following numbered clauses:

Clause 1: A robotic cleaning system comprising: a robotic cleaner comprising: a housing; and at least one wet cleaning element comprising at least one cleaning surface on an underside of the housing; and a docking station comprising: a base; a support extending laterally from the base, the support configured to receive at least a portion of the robotic cleaner on top of the support, the support defining a cavity; and at least one cleaning shuttle within the cavity and comprising at least one spray nozzle and at least one mechanical contacting element, the at least one spray nozzle configured to spray cleaning fluid onto at least a first portion of the at least one cleaning surface, the at least one mechanical contacting element configured to contact at least a second portion of the at least one cleaning surface.

Clause 2: The robotic cleaning system of clause 1, wherein the at least one cleaning shuttle is configured to move in at least one direction relative to the at least one cleaning surface while the at least one spray nozzle is spraying the cleaning fluid and the at least one mechanical contacting element is in contact with the at least one cleaning surface.

Clause 3: The robotic cleaning system of clause 1 or clause 2, wherein the first portion of the at least one cleaning surface comprises a first strip of the at least one cleaning surface comprising a first length equal to a length of the at least one cleaning surface and a first width that is less than a width of the at least one cleaning surface, wherein the second portion of the at least one cleaning surface comprises a second strip of the at least one cleaning surface comprising a second length equal to a length of the at least one cleaning surface and a second width that is less than a width of the at least one cleaning surface, and wherein, upon movement of the at least one cleaning shuttle in the at least one direction relative to the at least one cleaning surface, the at least one spray nozzle sprays the cleaning fluid on substantially an entire surface of the at least one cleaning surface and the at least one mechanical contacting element scrapes substantially the entire surface of the at least one cleaning surface.

Clause 4: The robotic cleaning system of any of clauses 1-3, wherein the at least one spray nozzle comprises two spray nozzles.

Clause 5: The robotic cleaning system of any of clauses 1-4, wherein the at least one spray nozzle comprises at least one of a fan nozzle, a deflector nozzle, or any combination thereof.

Clause 6: The robotic cleaning system of any of clauses 1-5, wherein the at least one spray nozzle is configured to spray the cleaning fluid at a pressure of 100-300 pounds per square inch.

Clause 7: The robotic cleaning system of any of clauses 1-6, wherein the at least one spray nozzle is configured to spray the cleaning fluid at a pressure of 10-30 pounds per square inch.

Clause 8: The robotic cleaning system of any of clauses 1-7, wherein the first portion of the at least one cleaning surface comprises a strip of the at least one cleaning surface comprising a first length equal to a length of the at least one cleaning surface and a first width that is less than a width of the at least one cleaning surface.

Clause 9: The robotic cleaning system of any of clauses 1-8, wherein the at least one mechanical contacting element comprises at least one of a vertical bar, a plurality of bristles, or any combination thereof.

Clause 10: The robotic cleaning system of any of clauses 1-9, wherein the at least one mechanical contacting element comprises a first vertical bar and a first plurality of bristles on a first side of the at least one spray nozzle and a second vertical bar and a second plurality of bristles on a second side of the at least one spray nozzle opposite the first side.

Clause 11: The robotic cleaning system of any of clauses 1-10, wherein the second portion of the at least one cleaning surface comprises a strip of the at least one cleaning surface comprising a first length equal to a length of the at least one cleaning surface and a first width that is less than a width of the at least one cleaning surface.

Clause 12: The robotic cleaning system of any of clauses 1-11, wherein the at least one wet cleaning element comprises a plate detachably connected to the underside of the housing, and wherein the at least one cleaning surface comprises a mop pad on an underside of the plate.

Clause 13: The robotic cleaning system of any of clauses 1-12, wherein the docking station further comprises: a cleaning fluid tank configured to store the cleaning fluid; and a pump configured to pump the cleaning fluid from the cleaning fluid tank to the at least one spray nozzle via at least one internal cleaning fluid conduit.

Clause 14: The robotic cleaning system of any of clauses 1-13, wherein the docking station further comprises: an accumulator fluidly coupled to the pump and configured to store the cleaning fluid under pressure; and a valve configured to release the cleaning fluid stored under pressure in the accumulator to the at least one spray nozzle via at least one internal cleaning fluid conduit.

Clause 15: The robotic cleaning system of any of clauses 1-14, wherein the docking station further comprises: an air compressor fluidly coupled to the accumulator and configured to increase pressure within the accumulator.

Clause 16: A docking station for a robotic cleaner, comprising: a base; a support extending laterally from the base, the support configured to receive at least a portion of a robotic cleaner on top of the support, the support defining a cavity; and at least one cleaning shuttle within the cavity and comprising at least one spray nozzle and at least one mechanical contacting element, the at least one spray nozzle configured to spray cleaning fluid onto at least a first portion of at least one cleaning surface of at least one wet cleaning element on an underside of the robotic cleaner, the at least one mechanical contacting element configured to contact at least a second portion of the at least one cleaning surface.

Clause 17: The docking station of clause 16, wherein the at least one cleaning shuttle is configured to move in at least one direction relative to the at least one cleaning surface while the at least one spray nozzle is spraying the cleaning fluid and the at least one mechanical contacting element is in contact with the at least one cleaning surface.

Clause 18: The docking station of clause 16 or clause 17, wherein the first portion of the at least one cleaning surface comprises a first strip of the at least one cleaning surface comprising a first length equal to a length of the at least one cleaning surface and a first width that is less than a width of the at least one cleaning surface, wherein the second portion of the at least one cleaning surface comprises a second strip of the at least one cleaning surface comprising a second length equal to a length of the at least one cleaning surface and a second width that is less than a width of the at least one cleaning surface, and wherein, upon movement of the at least one cleaning shuttle in the at least one direction relative to the at least one cleaning surface, the at least one spray nozzle sprays the cleaning fluid on substantially an entire surface of the at least one cleaning surface and the at least one mechanical contacting element scrapes substantially the entire surface of the at least one cleaning surface.

Clause 19: The docking station of any of clauses 16-18, wherein the at least one spray nozzle comprises at least one of a fan nozzle, a deflector nozzle, or any combination thereof, and wherein the at least one mechanical contacting element comprises at least one of a vertical bar, a plurality of bristles, or any combination thereof.

Clause 20: A method, comprising: receiving at least a portion of a robotic cleaner on top of a support extending laterally from a base of a docking station, the support defining a cavity; moving at least one cleaning shuttle within the cavity in at least one direction relative to at least one cleaning surface of at least one wet cleaning element on an underside of the robotic cleaner, the at least one cleaning shuttle comprising at least one spray nozzle and at least one mechanical contacting element; while moving the at least one cleaning shuttle, spraying, with the at least one spray nozzle, cleaning fluid onto at least a first portion of the at least one cleaning surface; and while moving the at least one cleaning shuttle, contacting, with the at least one mechanical contacting element, at least a second portion of the at least one cleaning surface.

These and other features and characteristics of the present disclosure, as well as the methods of operation and functions of the related elements of structures and the combination of parts and economics of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the disclosure are explained in greater detail below with reference to the exemplary embodiments or aspects that are illustrated in the accompanying schematic figures, in which:

FIG. 1A is a front perspective view of a docking station, according to non-limiting embodiments or aspects of the present disclosure;

FIG. 1B is a front and top-angle view of a lower portion of a docking station, according to non-limiting embodiments or aspects of the present disclosure;

FIG. 1C is a front perspective view of a lower portion of a docking station, including a close-up view of FIG. 1A, according to non-limiting embodiments or aspects of the present disclosure;

FIG. 2A is a front and top-angle view of a cleaning shuttle of a docking station, according to non-limiting embodiments or aspects of the present disclosure;

FIG. 2B is a cross-sectional side view of a cleaning shuttle of a docking station, according to non-limiting embodiments or aspects of the present disclosure;

FIG. 2C is a front and top-angle view of a cleaning shuttle of a docking station, according to non-limiting embodiments or aspects of the present disclosure;

FIG. 2D is a cross-sectional side view of a cleaning shuttle of a docking station, according to non-limiting embodiments or aspects of the present disclosure;

FIG. 3A is a rearward perspective view of a robotic cleaner, according to non-limiting embodiments or aspects of the present disclosure;

FIG. 3B is a rearward perspective view of a robotic cleaner, according to non-limiting embodiments or aspects of the present disclosure;

FIG. 3C is a rearward perspective view of a robotic cleaner, including a close-up view of FIG. 3B, according to non-limiting embodiments or aspects of the present disclosure;

FIG. 4 is a front perspective view of a robotic cleaner relative to a docking station, according to non-limiting embodiments or aspects of the present disclosure;

FIG. 5 is a diagram of a non-limiting embodiment or aspect of an environment in which systems, devices, products, apparatuses, and/or methods, described herein, may be implemented, according to the principles of the present disclosure;

FIG. 6 is a schematic diagram of a robotic cleaner, according to non-limiting embodiments or aspects of the present disclosure;

FIG. 7 is a diagram of one or more components, devices, and/or systems, according to some non-limiting embodiments or aspects;

FIG. 8 is a flowchart of a method of operating a robotic cleaning system, according to some non-limiting embodiments or aspects;

FIG. 9 is a schematic diagram of a pumping system for a cleaning shuttle of a docking station, according to non-limiting embodiments or aspects of the present disclosure;

FIG. 10 is a schematic diagram of a pumping system for a cleaning shuttle of a docking station, according to non-limiting embodiments or aspects of the present disclosure; and

FIG. 11 is a schematic diagram of a pumping system for a cleaning shuttle of a docking station, according to non-limiting embodiments or aspects of the present disclosure.

### DESCRIPTION

For purposes of the description hereinafter, the terms “upper”, “lower”, “right”, “left”, “vertical”, “horizontal”, “top”, “bottom”, “lateral”, “longitudinal,” and derivatives thereof shall relate to non-limiting embodiments or aspects as they are oriented in the drawing figures. However, it is to be understood that non-limiting embodiments or aspects may assume various alternative variations and step sequences, except where expressly specified to the contrary. It is also to be understood that the specific devices and processes illustrated in the attached drawings, and described in the following specification, are simply exemplary embodiments or aspects. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. The phase “based on” may also mean “in response to” where appropriate.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the internet, although it will be appreciated that communication may be facilitated over one or more public or private network environments and that various other arrangements are possible. Further, multiple computing devices (e.g., servers, desktop computers, mobile devices, etc.) directly or indirectly communicating in the network environment may constitute a “system.” Reference to “a server” or “a processor,” as used herein, may refer to a previously recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

The systems, devices, and methods described herein provide numerous technical advantages in systems for washing robotic cleaners, including robotic cleaners equipped for wet mode operation.

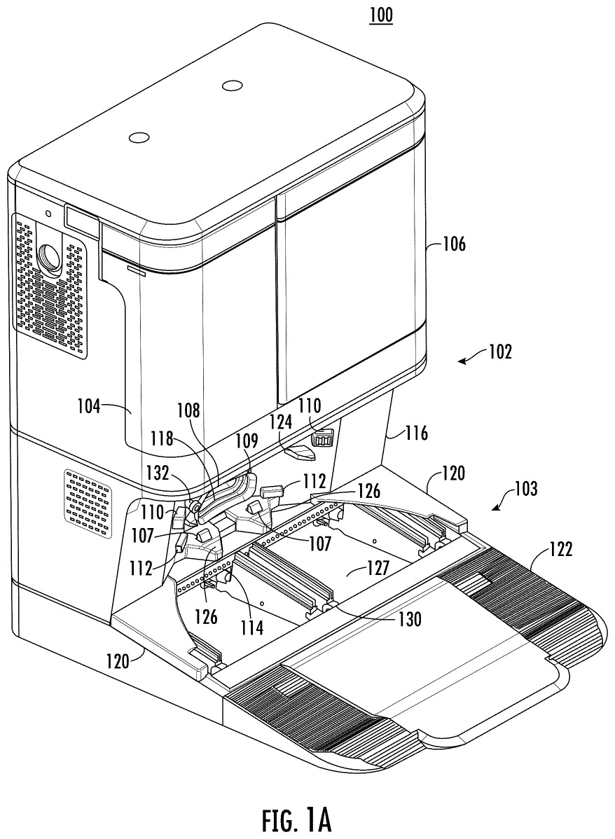

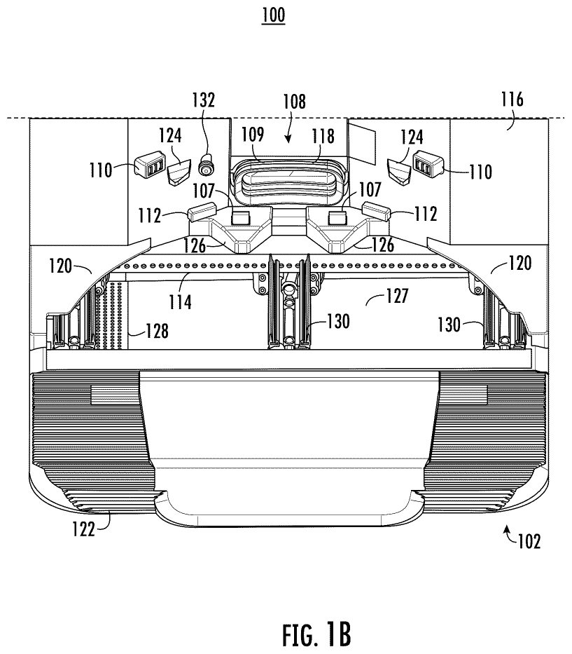

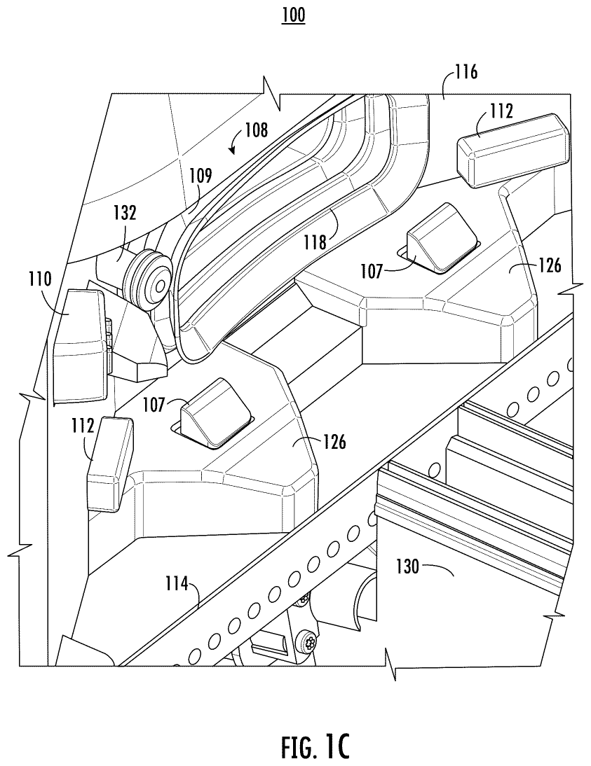

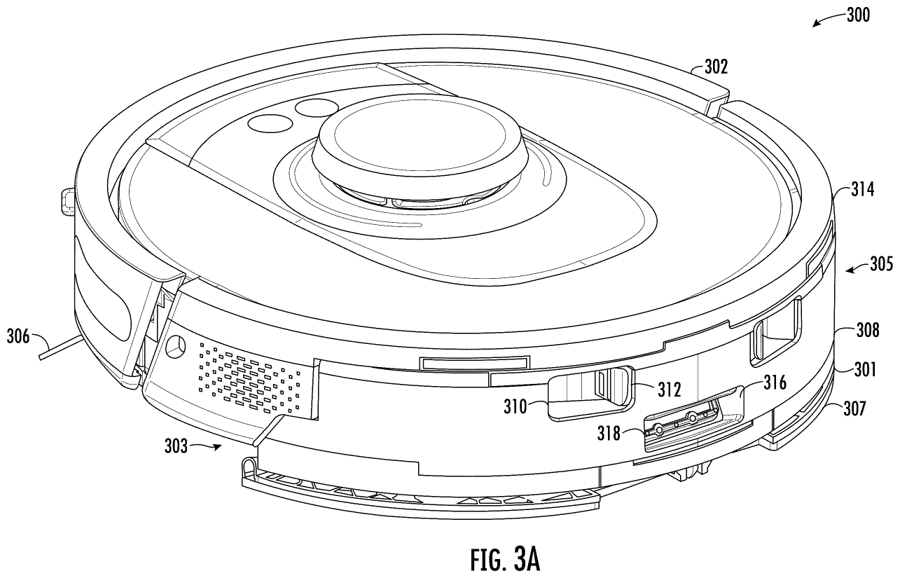

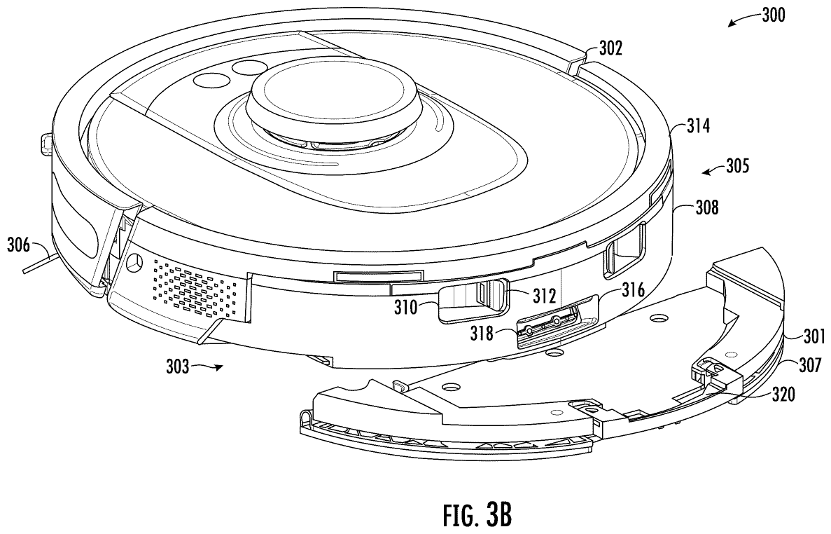

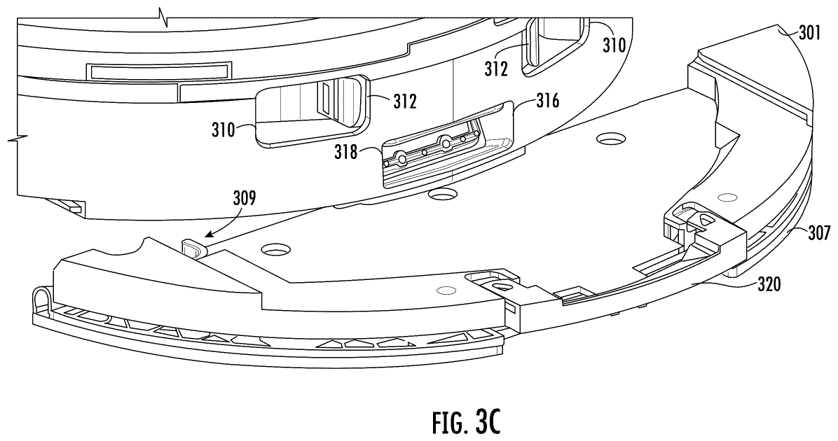

Referring now to FIGS. 1A-1C, FIG. 1A-IC are views of docking station 100, according to non-limiting embodiments or aspects of the present disclosure. In particular, FIG. 1A is a front perspective view of a complete docking station 100. FIG. 1B is a front and top-angle view of the lower base 102 and support 103 of docking station 100. FIG. 1C is a front perspective view of docking station 100, including a close-up of a portion of the view of FIG. 1A. Exemplary features of docking station 100 may be described in relation to exemplary features of robotic cleaner 300, which is further shown and described in connection with FIGS. 3A-3C.

In some non-limiting embodiments or aspects, docking station 100 may include base 102 forming a housing. Base 102 may include internal components for emptying and refilling robotic cleaner 300 when robotic cleaner 300 is docked with docking station 100. For example, base 102 may include an upper portion for housing a cleaning fluid tank 104, where new cleaning fluid may be loaded into cleaning fluid tank 104 for storage. New cleaning fluid may be delivered into robotic cleaner 300 from cleaning fluid tank 104 via cleaning fluid conduit 132. Additionally or alternatively, new cleaning fluid may be delivered to wash basin 127 from cleaning fluid tank 104 via internal cleaning fluid conduit 137. Cleaning fluid tank 104 may be removably coupled to base 102. Docking station 100 may include debris tank 106, which may be removably coupled to base 102 to allow debris tank 106 to be cleaned and emptied. Debris tank 106 may be configured to collect wet and/or dry debris collected by robotic cleaner 300 during a cleaning operation. Debris tank 106 may be filled with debris via, at least partly, docking station suction inlet 108.

Docking station 100 may include support 103 and/or suction housing 116, which may extend from support 103 to form the bottom of base 102. Suction housing 116 may enclose at least one suction motor used to create an inflow of air via docking station suction inlet 108. Suction housing 116 may further include an internal conduit to convey debris from robotic cleaner 300 to debris tank 106. Suction housing 116 may further define docking station suction inlet 108. Docking station suction inlet 108 may be configured to fluidly couple to at least a portion of robotic cleaner 300 such that at least a portion of debris stored within debris cup 308 of robotic cleaner 300 may be urged through docking station suction inlet 108 and into debris tank 106. For example, and as shown in FIG. 3A, debris cup 308 of robotic cleaner 300 may include outlet port 316 configured to fluidly couple to docking station suction inlet 108. Support 103 may be configured to improve the stability of docking station 100 on a surface to be cleaned (e.g., a floor). Support 103 may be further configured to hold at least one wet cleaning element 301 (e.g., a plate configured with a mop pad) of robotic cleaner 300 while robotic cleaner 300 is in a dry mode of operation (e.g., dry vacuuming). Charging contacts 110 may be included at the lower portion of base 102 and/or may be configured to electrically couple to robotic cleaner 300 such that one or more energy storage components (e.g., batteries) powering robotic cleaner 300 may be recharged. For example, power may be conveyed to robotic cleaner 300 via charging contacts 110 from a power supply that is internal or external to docking station 100 (e.g., a power outlet to which docking station 100 is plugged).

When robotic cleaner 300 seeks to recharge one or more batteries and/or empty debris cup 308 of robotic cleaner 300, robotic cleaner 300 may enter a docking mode. When in the docking mode, robotic cleaner 300 may approach docking station 100 in a manner that allows robotic cleaner 300 to electrically couple to charging contacts 110 and fluidly couple outlet port 316 of robotic cleaner 300 to docking station suction inlet 108. For the purpose of illustration, when in docking mode, robotic cleaner 300 may move to align itself relative to docking station 100, such that robotic cleaner 300 may become docked with docking station 100. For example, when in docking mode, robotic cleaner 300 may approach docking station 100 in a forward direction of travel until reaching a predetermined distance from docking station 100, stop at the predetermined distance and rotate approximately 180°, and proceed in a rearward direction of travel until robotic cleaner 300 docks with docking station 100.

As shown, docking station 100 may include a boot 109 that extends around docking station suction inlet 108. Boot 109 may be configured to engage debris cup 308, such that boot 109 extends around outlet port 316. Boot 109 may be resiliently deformable, such that boot 109 generally conforms to a shape of debris cup 308 of robotic cleaner 300. As such, boot 109 may be configured to sealingly engage debris cup 308. For example, boot 109 may be made of a natural or synthetic rubber, a foam, and/or any other resiliently deformable material. Boot 109 may define one or more ribs 118. Ribs 118 are configured to expand and/or compress in response to robotic cleaner 300 engaging boot 109, allowing boot 109 to deform to accommodate the form of debris cup 308.

In some non-limiting embodiments or aspects, when robotic cleaner 300 is engaging docking station 100 in a misaligned orientation, robotic cleaner 300 may be configured to pivot in place according to an oscillatory pattern. By pivoting in place, robotic cleaner 300 may cause outlet port 316 of robotic cleaner 300 to align with boot 109, such that outlet port 316 is fluidly coupled to docking station suction inlet 108.

In some non-limiting embodiments or aspects, base 102 and/or support 103 may define one or more stops configured to engage a portion of robotic cleaner 300 when robotic cleaner 300 is docking with docking station 100. For example, base 102 may define lower docking stops 112 and upper docking stops 124. One or more stops 112, 124 may be configured to prevent further movement of robotic cleaner 300 toward docking station 100 when robotic cleaner 300 is docking with docking station 100. In some non-limiting embodiments or aspects, upper docking stops 124 may define a guide surface having a taper. For example, a plurality of stops may be provided, each having a tapered guide surface such that engagement of robotic cleaner 300 with the guide surfaces urges robotic cleaner 300 towards an aligned orientation.

In some non-limiting embodiments or aspects, support 103 may define a ramp 122 to allow robotic cleaner 300 to travel onto support 103 from a surface to be cleaned (e.g., a floor). Ramp 122 may include a surface configured to be non-slip for at least one drive wheel 304 of robotic cleaner 300, such as a textured or coated surface. Support 103 may further define a guide surface 120 configured as an apron extending from base 102 toward ramp 122. Guide surface 120 may be configured to engage with an outer edge of at least one wet cleaning element 301 of robotic cleaner 300, creating a generally fluid seal between the outer edge of at least one wet cleaning element 301 and support 103.

When robotic cleaner 300 is docked with docking station 100, at least one wet cleaning element 301 may form a cover over wash basin 127 of support 103. Wash basin 127 may define a cavity in support 103 that houses a shuttle rail 114 along which at least one cleaning shuttle 130 (e.g., including upward-facing sprayers, scrubbers, agitators, and/or the like) may translate back and forth (e.g., along shuttle rail 114) to clean at least one wet cleaning element 301, when robotic cleaner 300 is docked with docking station 100. Cleaning shuttle 130 may emit cleaning fluid from cleaning fluid tank 104 to clean at least one wet cleaning element 301. Used cleaning fluid, after being emitted from cleaning shuttle 130, may drip into wash basin 127 and be carried, by fluid flow and gravity, to wash basin drain 128. Wash basin drain 128 may be mechanically coupled with a pump (not shown) to empty wash basin 127 of used cleaning fluid. The used cleaning fluid may be carried, via conduit (e.g., tubing), from wash basin drain 128 to debris tank 106. At least one detent 107 further holds robotic cleaner 300 in place, via at least one wet cleaning element 301, to prevent robotic cleaner 300 from coming dislodged during the cleaning process by cleaning shuttle 130.

In some non-limiting embodiments or aspects, at least a portion of the shuttle assembly (e.g., including shuttle rail 114 and cleaning shuttle 130) may be mechanically coupled to the at least one detent 107. In such a manner, at least one detent 107 may be configured to retract at least partly into the support 103 (e.g., detent housing 126) upon movement of the shuttle mechanism conveying cleaning shuttle 130 from a first position (e.g., directly underneath wet cleaning element 301) to a second position (e.g., tucked to the side of wash basin 127). For example, a connector (e.g., cable, armature, lever, etc.) may cause at least one detent 107 to retract when cleaning shuttle 130 has completed a cleaning cycle of at least one wet cleaning element 301 and move from an operational position to a non-operational position.

Docking station 100 may include at least one detent 107 extending vertically from support 103 (e.g., as shown, two detents 107). At least one detent 107 is configured to depress away from robotic cleaner 300 when at least a portion of robotic cleaner 300 (e.g., at least one wet cleaning element 301) travels over at least one detent 107 toward base 102 of docking station 100. When moving from a raised position to a depressed position, at least one detent 107 may recess into at least one detent housing 126. At least one detent housing 126 may include a cavity, into which at least one detent 107 may recess when being depressed. At least one detent housing 126 may further include a biasing mechanism (e.g., compression spring, torsion spring, elastomeric material, and/or the like) to urge at least one detent 107 back to a raised position when not opposed by a greater downward force. In some non-limiting embodiments or aspects, docking station 100 may include a plurality of detents 107, which may be mechanically coupled together at least partly within one or more detent housings 126. In such cases, movement of each detent 107 may be coupled such that each detent 107 raises or lowers together. At least one detent 107 may raise when at least a portion (e.g., engaging surface 320) of at least one wet cleaning element 301 of robotic cleaner 300 has passed over at least one detent 107. At least one detent 107 may contact at least a portion (e.g., engaging surface 320) of at least one wet cleaning element 301 when robotic cleaner 300 is docked with docking station 100.

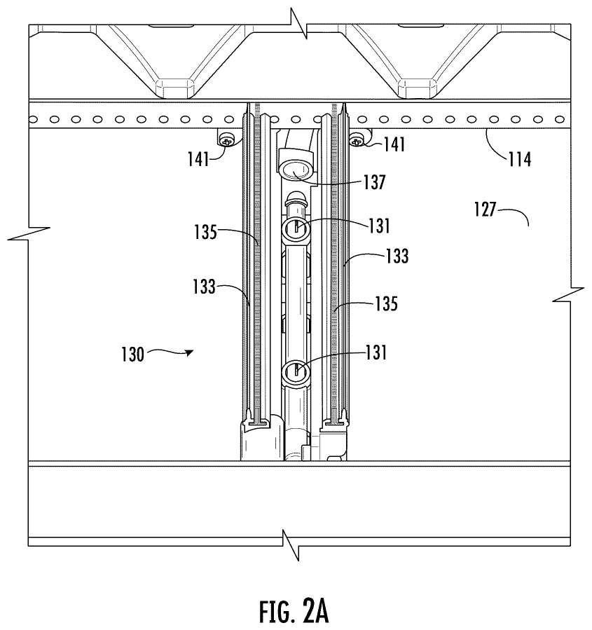

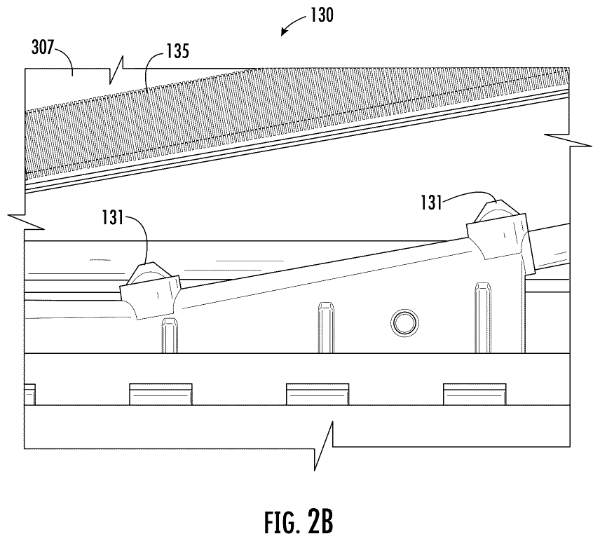

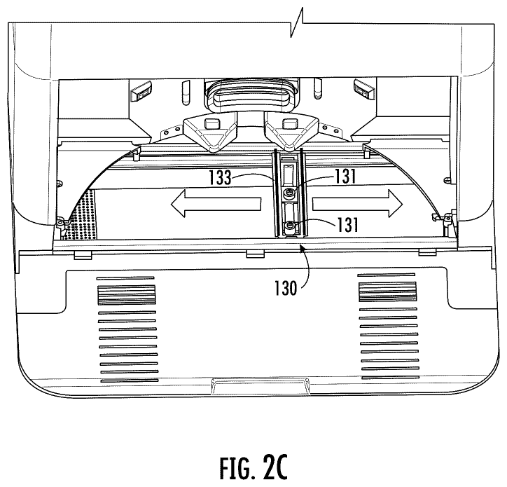

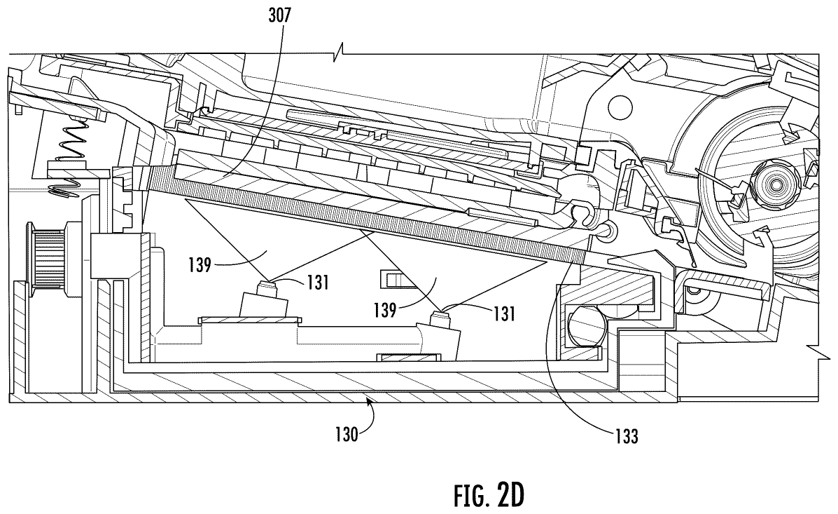

Referring now to FIGS. 2A-2D, FIGS. 2A-2D are views of a portion of docking station 100 including cleaning shuttle 130. FIG. 2A is a front and top-angle view of an example cleaning shuttle 130 of docking station 100, according to non-limiting embodiments or aspects of the present disclosure. FIG. 2B is a cross-sectional side view of an example cleaning shuttle 130 of docking station 100, according to non-limiting embodiments or aspects of the present disclosure. FIG. 2C is a front and top-angle view of an example cleaning shuttle 130 of docking station 100, according to non-limiting embodiments or aspects of the present disclosure. FIG. 2D is a cross-sectional side view of an example cleaning shuttle 130 of docking station 100, according to non-limiting embodiments or aspects of the present disclosure.

In some non-limiting embodiments or aspects, support 103 may extend laterally from base 102, as described herein. Support 103 may be configured to receive at least a portion of robotic cleaner 300 on top of support 103, as described herein. In some non-limiting embodiments or aspects, support 103 may define a cavity, such as wash basin 127, as described herein.

In some non-limiting embodiments or aspects, at least one cleaning shuttle 130 (e.g., one cleaning shuttle 130, a plurality of cleaning shuttles 130, and/or the like) may be included within the cavity (e.g., wash basin 127). Each cleaning shuttle may include at least one spray nozzle 131 and/or at least one mechanical contacting element (e.g., bar 133, bristles 135, and/or the like). For example, each spray nozzle 131 may be configured to spray cleaning fluid 139 onto at least a portion of cleaning surface 307 of wet cleaning element 301 of robotic cleaner 300, as described herein. Additionally or alternatively, each mechanical contacting elements (e.g., bar 133, bristles 135, and/or the like) may be configured to contact at least a portion of cleaning surface 307.

In some non-limiting embodiments or aspects, cleaning fluid 139 may be delivered to wash basin 127 and/or spray nozzle 131 from cleaning fluid tank 104 via internal cleaning fluid conduit 137, as described herein.

In some non-limiting embodiments or aspects, cleaning shuttle 130 may be configured to move in at least one direction (e.g., side-to-side, perpendicular from the direction of travel of robotic cleaner 300 when docking with and/or leaving docking station 100, and/or the like) relative to cleaning surface 307 while spray nozzle(s) 130 is spraying cleaning fluid 139 and/or while the mechanical contacting element(s) (e.g., bar 133, bristles 135, and/or the like) is in contact with cleaning surface 307, as described herein. For example, cleaning shuttle 130 may move side-to-side within wash basin 127 along shuttle rails 114 (e.g., as shown in FIG. 2C). In some non-limiting embodiments or aspects, cleaning shuttle 130 may move using drive mechanism 141 (e.g., at least one motor, at least one mechanical linkage, belt, and/or pulley connected to at least one motor, any combination thereof, and/or the like). Additionally or alternatively, drive mechanism 141 may include an arm that moves in a radius overlapping with robotic cleaner 130 and/or cleaning surface 307.

In some non-limiting embodiments or aspects, spray nozzle(s) 130 may spray cleaning fluid 139 onto a first portion of cleaning surface 307. For example, the first portion may include a first strip of cleaning surface 307 including a first length substantially equal to a length of cleaning surface 307 (e.g., equal to the length of cleaning surface 307, at least 90% of the length of cleaning surface 307, and/or the like) and a first width that is less than a width of cleaning surface 307 (e.g., a narrow width, such as the width of a spray pattern of a fan nozzle, a deflector nozzle, any combination thereof, and/or the like).

In some non-limiting embodiments or aspects, the mechanical contacting element(s) (e.g., bar 133, bristles 135, and/or the like) may contact a second portion of cleaning surface 307. For example, the second portion may include a second strip of cleaning surface 307 including a second length substantially equal to the length of cleaning surface 307 (e.g., equal to the length of cleaning surface 307, at least 90% of the length of cleaning surface 307, and/or the like) and a second width that is less than a width of cleaning surface 307 (e.g., a narrow width, such as the width of bar 133, bristles 135, any combination thereof, and/or the like).

In some non-limiting embodiments or aspects, upon movement of cleaning shuttle 130 in the at least one direction relative to cleaning surface 307 (e.g., a traversal from a first side of cleaning surface 307 across substantially the entire width of cleaning surface 307 to a second side of cleaning surface 307 opposite the first side), spray nozzle(s) 130 may spray the cleaning fluid on substantially an entire surface of cleaning surface(s) 137 and/or the mechanical contacting element(s) (e.g., bar 133, bristles 135, and/or the like) may scrape and/or brush substantially the entire surface of the at least one cleaning surface.

In some non-limiting embodiments or aspects, a plurality of spray nozzles 130 may be included on cleaning shuttle 130. For example, two spray nozzles 130 may be included on cleaning shuttle 130. In some non-limiting embodiments or aspects, more than two spray nozzles 130 may be included on cleaning shuttle 130.

In some non-limiting embodiments or aspects, each spray nozzle 130 may include at least one of a fan nozzle, a deflector nozzle, any combination thereof, and/or the like.

In some non-limiting embodiments or aspects, spray nozzle(s) 130 may be configured to spray the cleaning fluid at a pressure of 100-300 pounds per square inch (psi). In some non-limiting embodiments or aspects, spray nozzle(s) 130 may be configured to spray the cleaning fluid at a pressure of 10-30 pounds per square inch.

In some non-limiting embodiments or aspects, spray nozzle(s) 130 may spray cleaning fluid 139 onto a portion of cleaning surface 307. For example, the portion may include a first strip of cleaning surface 307 including a first length substantially equal to a length of cleaning surface 307 (e.g., equal to the length of cleaning surface 307, at least 90% of the length of cleaning surface 307, and/or the like) and a first width that is less than a width of cleaning surface 307 (e.g., a narrow width, such as the width of a spray pattern of a fan nozzle, a deflector nozzle, any combination thereof, and/or the like).

In some non-limiting embodiments or aspects, the mechanical contacting element(s) may include at least one of a vertical bar 133, a plurality of bristles 135, any combination thereof, and/or the like. For example, the mechanical contacting element(s) may include a first vertical bar 133 and a first plurality of bristles 135 on a first side of spray nozzle(s) 130 and a second vertical bar 133 and a second plurality of bristles 135 on a second side of spray nozzle(s) 130 opposite the first side.

In some non-limiting embodiments or aspects, the mechanical contacting element(s) (e.g., bar 133, bristles 135, and/or the like) may contact at least one portion of cleaning surface 307. For example, the portion(s) may include at least one strip of cleaning surface 307 including a second length substantially equal to the length of cleaning surface 307 (e.g., equal to the length of cleaning surface 307, at least 90% of the length of cleaning surface 307, and/or the like) and a second width that is less than a width of cleaning surface 307 (e.g., a narrow width, such as the width of bar 133, the width of bristles 135, the width of bar 133 and bristles 135 (e.g., arranged adjacent to each other), any combination thereof, and/or the like).

In some non-limiting embodiments or aspects, wet cleaning element 301 may include a plate detachably connected to the underside of housing 305 of robotic cleaner 300, as described herein. Additionally or alternatively, cleaning surface 307 may include a mop pad on an underside of the plate (and/or an underside of housing 305).

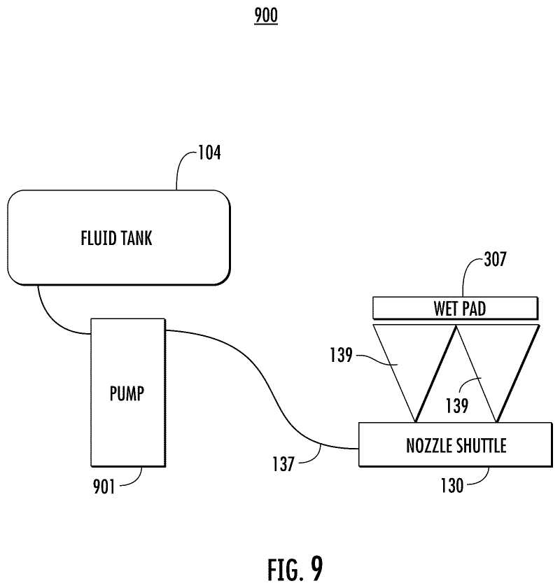

In some non-limiting embodiments or aspects, docking station 100 may further include cleaning fluid tank 104 configured to store the cleaning fluid 139, as described herein. Additionally or alternatively, docking station 100 may include a pump 901 configured to pump cleaning fluid 139 (e.g., from cleaning fluid tank 104) to spray nozzle(s) 131 via at least one internal cleaning fluid conduit 137, as described herein (see, e.g., FIGS. 9-11).

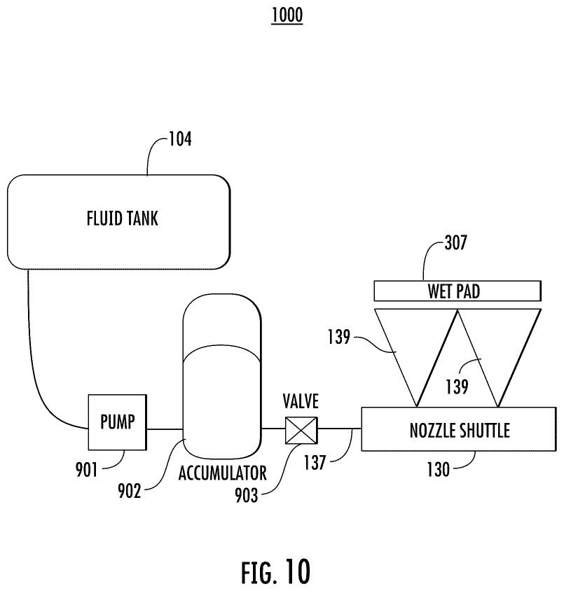

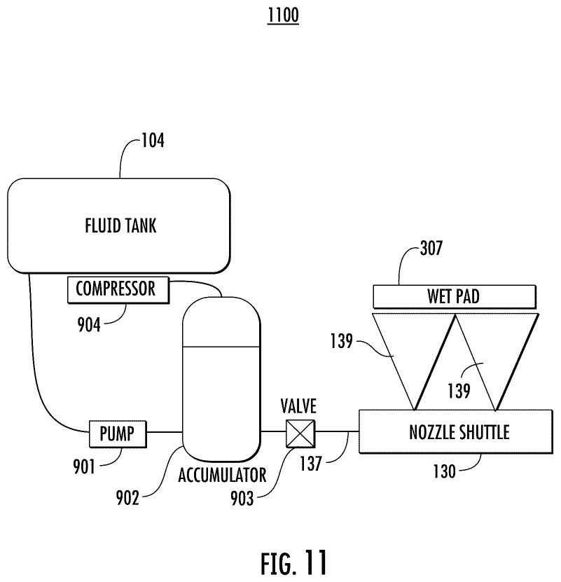

In some non-limiting embodiments or aspects, docking station 100 may further include accumulator 902 fluidly coupled to pump 901 and configured to store cleaning fluid 139 under pressure, as described herein. Additionally or alternatively, docking station 100 may include valve 903 configured to release cleaning fluid 139 stored under pressure (e.g., in accumulator 902) to spray nozzle 130 (e.g., via at least one internal cleaning fluid conduit 137), as described herein (see, e.g., FIGS. 10 and 11).

In some non-limiting embodiments or aspects, docking station 100 may further include compressor 904 (e.g., an air compressor) fluidly coupled to accumulator 902 and configured to increase pressure within accumulator 902, as described herein (see, e.g., FIG. 11).

Referring now to FIGS. 3A-3C, FIGS. 3A-3C are rearward perspective views of robotic cleaner 300, according to non-limiting embodiments or aspects of the present disclosure. FIG. 3A is a first rearward perspective view of robotic cleaner 300 with at least one wet cleaning element 301 attached to housing 305 of robotic cleaner 300. FIG. 3B is a second rearward perspective view of robotic cleaner 300 with at least one wet cleaning element 301 detached from housing 305 of robotic cleaner 300. FIG. 3C is a third rearward perspective view that is a close-up view of FIG. 3B, focusing on at least one wet cleaning element 301. As shown, robotic cleaner 300 includes at least one wet cleaning element 301 (e.g., having a releasable attachment 309), housing 303, displaceable bumper 302, at least one drive wheel (not shown), side brush 306, debris cup 308, and outlet port 316. At least a portion of displaceable bumper 302 and debris cup 308 may be disposed on opposing sides of the at least one drive wheel. As such, displaceable bumper 302 may be positioned in a forward portion of robotic cleaner 300 and debris cup 308 may be positioned in a rearward portion of robotic cleaner 300.

As shown, robotic cleaner 300 includes a release 310 for debris cup 308 positioned between a top surface 314 of debris cup 308 and the outlet port 316. Release 310 may include opposing depressable triggers 312 configured to be actuated in opposing directions. Actuation of triggers 312 may cause at least a portion of debris cup 308 to disengage a portion of robotic cleaner 300 such that debris cup 308 may be removed therefrom.

Outlet port 316 may include an evacuation pivot door 318. Evacuation pivot door 318 may be configured to transition from an open position (e.g., when robotic cleaner 300 is docked with docking station 100) and a closed position (e.g., when robotic cleaner 300 is carrying out a cleaning operation). When transitioning to the closed position, evacuation pivot door 318 may pivot in a direction of debris cup 308. As such, during a cleaning operation, a suction force generated by a suction motor of robotic cleaner 300 may urge evacuation pivot door 318 toward the closed position. Additionally or alternatively, a biasing mechanism (e.g., a compression spring, a torsion spring, an elastomeric material, and/or any other biasing mechanism) may urge evacuation pivot door 318 toward the closed position. When transitioning to the open position, evacuation pivot door 318 may pivot in a direction away from debris cup 308. As such, when robotic cleaner 300 is docked with docking station 100, the suction generated by a suction motor of docking station 100 may urge evacuation pivot door 318 towards the open position.

At least one wet cleaning element 301 is detachably connected (e.g., using releasable attachment 309) to an underside 303 of housing 305 of robotic cleaner 300. Releasable attachments 309 usable for connecting wet cleaning element 301 to housing 305 may include, but are not limited to, friction clips, snug-fit adaptors, and/or the like. At least one wet cleaning element 301 includes an engaging surface 320 configured to contact at least one detent 107 when robotic cleaner 300 is docked with docking station 100. At least one wet cleaning element 301 may include at least one cleaning surface 307 (e.g., mop pad) that is configured to be imbued with a cleaning solution and contact a floor surface to be cleaned by robotic cleaner 300. At least one wet cleaning element 301 may be detached from housing 305 of robotic cleaner 300 by the action of being fixed in place by at least one detent 107, in combination with at least one drive wheel of robotic cleaner 300 causing robotic cleaner 300 to travel away from base 102 of docking station 100.

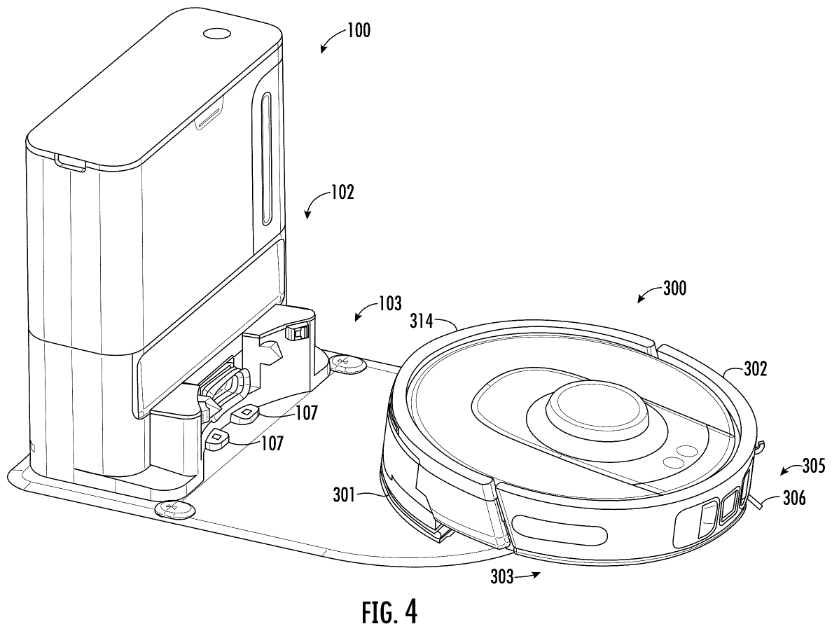

Referring now to FIG. 4, FIG. 4 is a front perspective view of robotic cleaner 300 relative to docking station 100, according to non-limiting embodiments or aspects of the present disclosure. As shown in FIG. 4, robotic cleaner 300 has wet cleaning element 301 attached to underside 303 of robotic cleaner 300. As depicted, robotic cleaner 300 may be departing from docking station 100 to engage in cleaning operation, resting on support 103 of docking station 100, or returning to dock with docking station 100. For a docking maneuver, robotic cleaner 300 may approach docking station 100 and travel along support 103 toward base 102 of docking station 100. As such, robotic cleaner 300 may dock with docking station 100 (e.g., make final connection with docking stops 112, 124, charging contacts 110, detents 107, cleaning fluid conduit 132, boot 109, etc.). If robotic cleaner 300 seeks to leave docking station 100, robotic cleaner 300 may travel away from base 102 of docking station 100.

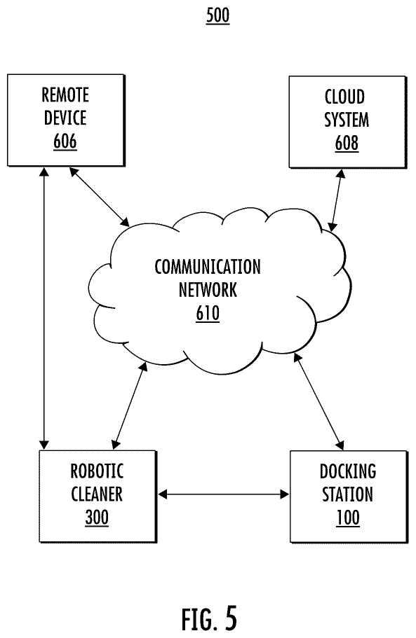

Referring now to FIG. 5, FIG. 5 is a diagram of an example environment 500 in which devices, systems, and/or methods, described herein, may be implemented. As shown in FIG. 5, environment 500 may include remote device 606, cloud system 608, robotic cleaner 300, docking station 100, and communication network 610. Remote device 606, cloud system 608, robotic cleaner 300, and docking station 100 may interconnect (e.g., establish a connection to communicate) via one or more wired connections, wireless connections, or a combination of wired and wireless connections. In some non-limiting embodiments or aspects, environment 500 may further include external sensors, operational boundary devices, and/or the like.

Docking station 100 may include one or more computing devices configured to communicate with remote device 606, cloud system 608, and/or robotic cleaner 300 at least partly over communication network 610. Docking station 100 may be configured to monitor its operational parameters, such as the unused cleaning fluid level, used cleaning fluid level, debris tank status, docking status, robotic cleaner status, and/or the like. Docking station 100 may communicate with robotic cleaner 300 to determine when to extend or retract detents 107 electronically in support 103 of docking station 100, to allow the conversion from wet mode to dry mode operation and vice versa, in certain electronic-controlled embodiments or aspects.

Robotic cleaner 300 may include one or more computing devices configured to communicate with remote device 606, cloud system 608, and/or docking station 100 at least partly over communication network 610. Robotic cleaner 300 may be configured to autonomously carry out cleaning operations in wet mode or dry mode, and may further autonomous convert between those modes in concert with docking station 100. Robotic cleaner 300 may communicate with remote device 606 to determine an operational mode and relay parameters of robotic cleaner's 300 operations to remote device 606, including an operational mode status. Robotic cleaner 300 may further communicate with cloud system 608 to relay operational parameters, including cleaning statuses, operational modes, obstacles detected, errors, failures, obstacles, and/or the like. Robotic cleaner 300 may further communicate with docking station 100 to cause docking station to extend or retract detents 107, in certain electronic-controlled embodiments or aspects.

Remote device 606 may include one or more computing devices configured to communicate with cloud system 608, robotic cleaner 300, and/or docking station 100 at least partly over communication network 610. Remote device 606 may be configured to instruct robotic cleaner 300 to change modes of operation and carry out docking or undocking procedures. Remote device 606 may further communicate with robotic cleaner 300 to receive status updates and parameters of cleaning operation. Remote device 606 may communicate with cloud system to view historical and real-time operation parameters of robotic cleaner 300. Remote device 606 may further communicate with docking station 100 to receive parameters and status information of docking station 100 operation.

Cloud system 608 may include one or more computing devices configured to communicate with remote device 606, robotic cleaner 300, and/or docking station 100 at least partly over communication network 610. Cloud system 608 may be configured to receive operational information from robotic cleaner 300 and/or docking station 100 and store at least some of the information in memory. Cloud system 608 may communicate with remote device 606 to transmit at least a portion of real-time or stored operational information that is received from robotic cleaner 300 and/or docking station 100. Cloud system 608 may further store cleaning operation parameters and preferences for a cleaning system and/or user. Cloud system 608 may communicate operation instructions to robotic cleaner 300.

Communication network 610 may include one or more wired and/or wireless networks over which the systems and devices of environment 500 may communicate. For example, communication network 610 may include a cellular network (e.g., a long-term evolution (LTE®) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 5 are provided as an example. There may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally or alternatively, a set of devices (e.g., one or more devices) of environment 500 may perform one or more functions described as being performed by another set of devices of environment 500.

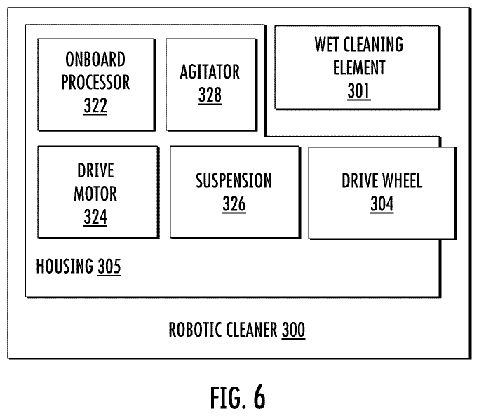

Referring now to FIG. 6, FIG. 6 is a schematic diagram or robotic cleaner 300, according to some non-limiting embodiments or aspects. Robotic cleaner 300 may include housing 305 generally defining the body of robotic cleaner 300. Housing 305 may include controls (e.g., buttons) on a top surface of housing 305, to initiate certain operations, including, but not limited to, autonomous cleaning, spot cleaning, docking, and/or the like. Housing 305 may further include indicators (e.g., light emitting diodes (LEDs)) to indicate operations, battery charge levels, errors, and other information. Housing 305 may further include device components for carrying out cleaning operations, including, but not limited to, suction conduit, agitators 328, air jet assemblies, suction motor, clean air outlets, air outlet ports, fan outlets, clean air exhaust ducts, exhaust ducts, bump sensors (e.g., associated with displaceable bumper 302), wall sensors, cliff sensors, internal ducting, and/or the like. Housing 305 may include and/or be mechanically coupled to suspension 326 that is adjustable to raise and lower a clearance profile of housing 305 from the surface to be cleaned (e.g., floor). The other end of suspension 326 may be mechanically coupled with one or more wheels for conveying robotic cleaner 300 across the surface to be cleaned, which may include one or more drive wheels 304. One or more drive wheels 304 may extend at least partially outside of housing 305. The mechanical power for propelling robotic cleaner 300 across the surface to be cleaned may be provided by one or more drive motors 324, which may draw electrical power from one or more batteries stored onboard robotic cleaner 300, such as in housing 305. In some non-limiting embodiments or aspects, one or more drive wheels 304 may be partially housed in and partially extend from housing 305 to contact the surface to be cleaned.

Robotic cleaner 300 may further include one or more wet cleaning elements 301 that are configured to be removably attached from housing 305. When robotic cleaner 300 is in a wet mode of operation (e.g., mopping), one or more wet cleaning elements 301 may be attached to an underside 303 of robotic cleaner 300, and each wet cleaning element 301 may include a cleaning surface 307 (e.g., a mop pad) for contacting and cleaning the surface to be cleaned. Robotic cleaner 300 may include an onboard tank for cleaning solution, which may be delivered to cleaning surface 307 via conduit at least partially within housing 305 from the onboard tank to the cleaning surface 307. One or more wet cleaning elements 301 may each include an engaging surface 320 configured to interface with and contact one or more detent 107 of docking station 100, to allow wet cleaning elements 301 to be detached from housing 305 of robotic cleaner 300.

Robotic cleaner may further include one or more agitators 328 that are configured to carry out a dry mode of operation (e.g., vacuuming). For example, agitator 328 may include a rotating agitator including bristles, fabric, or other cleaning elements, or any combination thereof, around the outside of agitator 328. A rotating agitator 328 may include, for example, strips of bristles in combination with strips of rubber or elastomer material. A rotating agitator 328 may also be removable to allow the rotating agitator 328 to be cleaned more easily and allow the user to change the size of the rotating agitator 328, change the type of bristles on the rotating agitator 328, and/or remove the rotating agitator 328 depending on the intended application. Robotic cleaner 300 may further include, as an agitator 328, a bristle strip on an underside of housing 305 and adjacent a portion of suction conduit, to contact the surface to be cleaned and urge debris toward the suction conduit of robotic cleaner 300. In some non-limiting embodiments or aspects, one or more agitators 328 may be used in concert with at least one wet cleaning element 301 for carrying out wet mode operation of robotic cleaner 300. Additionally or alternatively, one or more agitators 328 may be at least partially disabled, occluded, covered, and/or the like, by at least one wet cleaning element 301 when robotic cleaner 300 is in a wet mode of operation.

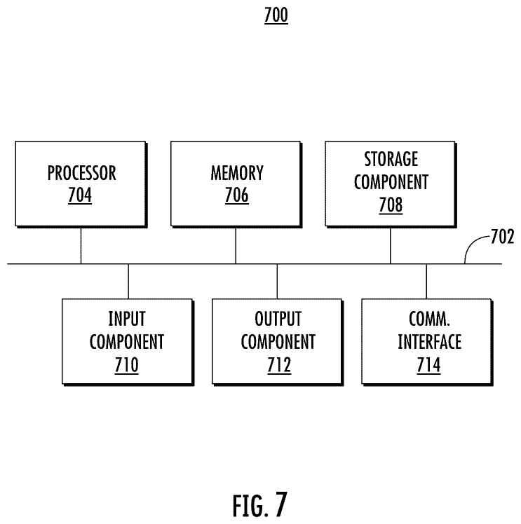

Robotic cleaner 300 may further include onboard processor 322 (e.g., a controller). Onboard processor 322 may be communicatively connected to sensors of robotic cleaner 300 (e.g., bump sensors, wheel drop sensors, rotation sensors, forward obstacle sensors, side wall sensors, cliff sensors, etc.) and to driving mechanisms (e.g., drive motor 324, motors configured to control one or more features of an air jet assembly, agitator 328 assembly, side brush 306, etc.). Thus, onboard processor 322 may be configured to operate one or more drive wheels 304, air jet assemblies, agitators 328, etc., in response to sensed conditions. Onboard processor 322 may operate robotic cleaner 300 to perform various operations, such as autonomous cleaning (e.g., including randomly moving and turning, wall following, obstacle following, etc.), spot cleaning, and docking. Onboard processor 322 may also operate robotic cleaner 300 to avoid obstacles and cliffs and to escape from various situations where robotic cleaner 300 may become stuck. Onboard processor 322 may include one or more hardware components, such as described in FIG. 7.

Referring now to FIG. 7, FIG. 7 is a diagram of example components of device 700 according to some non-limiting embodiments or aspects. Device 700 may correspond to one or more devices of docking station 100, robotic cleaner 300, remote device 606, cloud system 608, and/or communication network 610 as shown in FIG. 5, or onboard processor 322 or robotic cleaner 300 as shown in FIG. 6. In some non-limiting embodiments or aspects, such systems or devices may include at least one device 700 and/or at least one component of device 700.

As shown in FIG. 7, device 700 may include bus 702, processor 704, memory 706, storage component 708, input component 710, output component 712, and communication interface 714. Bus 702 may include a component that permits communication among the components of device 700. In some non-limiting embodiments or aspects, processor 704 may be implemented in hardware, firmware, or a combination of hardware and software. For example, processor 704 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 706 may include random access memory (RAM), read only memory (ROM), and/or another type of dynamic or static storage device (e.g., flash memory, magnetic memory, optical memory, etc.) that stores information and/or instructions for use by processor 704.

Storage component 708 may store information and/or software related to the operation and use of device 700. For example, storage component 708 may include a hard disk (e.g., a magnetic disk, an optical disk, a magneto-optic disk, a solid state disk, etc.) and/or another type of computer-readable medium.

Input component 710 may include a component that permits device 700 to receive information, such as via user input (e.g., a touch screen display, a keyboard, a keypad, a mouse, a button, a switch, a microphone, etc.). Additionally or alternatively, input component 710 may include a sensor for sensing information (e.g., a global positioning system (GPS) component, an accelerometer, a gyroscope, an actuator, etc.). Output component 712 may include a component that provides output information from device 700 (e.g., a display, a speaker, one or more light-emitting diodes (LEDs), etc.).

Communication interface 714 may include a transceiver-like component (e.g., a transceiver, a separate receiver and transmitter, etc.) that enables device 700 to communicate with other devices, such as via a wired connection, a wireless connection, or a combination of wired and wireless connections. Communication interface 714 may permit device 700 to receive information from another device and/or provide information to another device. For example, communication interface 714 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 700 may perform one or more processes described herein. Device 700 may perform these processes based on processor 704 executing software instructions stored by a computer-readable medium, such as memory 706 and/or storage component 708. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 706 and/or storage component 708 from another computer-readable medium or from another device via communication interface 714. When executed, software instructions stored in memory 706 and/or storage component 708 may cause processor 704 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

The number and arrangement of components shown in FIG. 7 are provided as an example. In some non-limiting embodiments or aspects, device 700 may include additional components, fewer components, different components, or differently arranged components than those shown in FIG. 7. Additionally or alternatively, a set of components (e.g., one or more components) of device 700 may perform one or more functions described as being performed by another set of components of device 700.

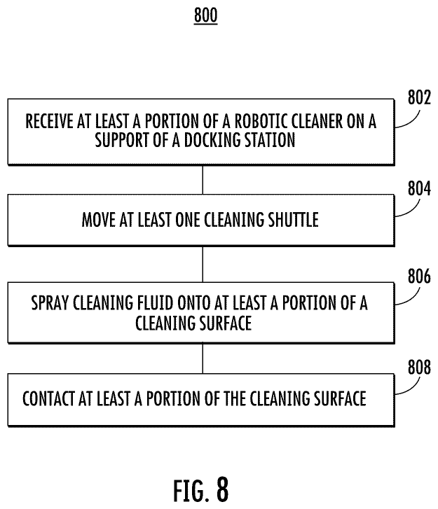

Referring now to FIG. 8, FIG. 8 is a flowchart of a non-limiting embodiment or aspect of a process 800 for washing robotic cleaners, according to some non-limiting embodiments or aspects. The steps shown in FIG. 8 are for example purposes only. It will be appreciated that additional, fewer, different, and/or a different order of steps may be used in some non-limiting embodiments or aspects. In some non-limiting embodiments or aspects, one or more of the steps of process 800 may be performed (e.g., completely, partially, and/or the like) by docking station 100 (e.g., cleaning shuttle 130 thereof). In some non-limiting embodiments or aspects, one or more of the steps of process 800 may be performed (e.g., completely, partially, and/or the like) by another system, another device, another group of systems, or another group of devices, separate from or including docking station 100, such as robotic cleaner 300, remote device 606, and/or cloud system 608.

As shown in FIG. 8, at step 802, process 800 may include receiving at least a portion of a robotic cleaner on a support of a docking station. For example, at least a portion of robotic cleaner 300 may be received on top of support 103 extending laterally from base 102 of a docking station 100, as described herein.

In some non-limiting embodiments or aspects, support 103 may define a cavity (e.g., wash basin 127), as described herein.

As shown in FIG. 8, at step 804, process 800 may include moving at least one cleaning shuttle. For example, cleaning shuttle 130 may be moved (e.g., by draft mechanism 141) within the cavity (e.g., wash basin 127) in at least one direction relative to at least one cleaning surface 307 of at least one wet cleaning element 301 on an underside of robotic cleaner 300, as described herein.

In some non-limiting embodiments or aspects, the cleaning shuttle(s) 130 may include at least one spray nozzle 130 and/or at least one mechanical contacting element (e.g., bar 133, bristles 135, and/or the like), as described herein.

As shown in FIG. 8, at step 806, process 800 may include spraying cleaning fluid onto at least a portion of the cleaning surface(s). For example, spray nozzle(s) 130 may spray cleaning fluid 139 onto at least a first portion of the cleaning surface 307, as described herein.

In some non-limiting embodiments or aspects, spray nozzle(s) 130 may spray cleaning fluid 139 while cleaning shuttle 130 is moving.

As shown in FIG. 8, at step 808, process 800 may include contacting at least a portion of the cleaning surface(s). For example, the mechanical contacting element(s) (e.g., bar 133, bristles 135, and/or the like) may contact at least a second portion of cleaning surface 307, as described herein.

In some non-limiting embodiments or aspects, the mechanical contacting element(s) (e.g., bar 133, bristles 135, and/or the like) may contact cleaning surface 307 while cleaning shuttle 130 is moving (e.g., to scrape and/or brush cleaning surface 307 with the mechanical contacting element(s)), as described herein.

Referring now to FIG. 9, FIG. 9 is a schematic diagram of an example pumping system 900 for cleaning shuttle 130 of docking station 100, according to non-limiting embodiments or aspects of the present disclosure.

In some non-limiting embodiments or aspects, docking station 100 may further include cleaning fluid tank 104 configured to store the cleaning fluid 139, as described herein. Additionally or alternatively, docking station 100 may include pump 901, which may be configured to pump cleaning fluid 139 (e.g., from cleaning fluid tank 104) to spray nozzle(s) 131 of cleaning shuttle 130 via at least one internal cleaning fluid conduit 137. As such, spray nozzle(s) 131 may spray cleaning fluid 139 (e.g., onto at least a portion of cleaning surface 307), as described herein.

In some non-limiting embodiments or aspects, pump 901 may be sufficiently powerful to pump cleaning fluid 139 through spray nozzle(s) 131 at a target pressure, as described herein. For example, the target pressure may be 100-300 psi, 10-30 psi, and/or the like. For the purpose of illustration, pump 901 may be a single on-demand pump sufficient to achieve both target pressure and target flow.

Referring now to FIG. 10, FIG. 10 is a schematic diagram of an example pumping system 1000 for cleaning shuttle 130 of docking station 100, according to non-limiting embodiments or aspects of the present disclosure.

In some non-limiting embodiments or aspects, docking station 100 may further include accumulator 902 fluidly coupled to pump 901. For example, accumulator 902 may be configured to store cleaning fluid 139 pumped by pump 901 from cleaning fluid tank 104 under pressure. Additionally or alternatively, docking station 100 may include valve 903 configured to release cleaning fluid 139 stored under pressure (e.g., in accumulator 902) to spray nozzle 130 (e.g., via at least one internal cleaning fluid conduit 137). As such, spray nozzle(s) 131 may spray cleaning fluid 139 (e.g., onto at least a portion of cleaning surface 307), as described herein.

In some non-limiting embodiments or aspects, pump 901, accumulator 902, and valve 903 may be configured to provide cleaning fluid 139 through spray nozzle(s) 131 at a target pressure (e.g., even if pump 901 may not be powerful enough to pump cleaning fluid 139 at the target pressure and target flow rate on its own). For the purpose of illustration, pump 901 may be a pump sufficient to achieve target pressure (e.g., but less than target flow). Accumulator 902 may include a pressure vessel that has a bladder inside of it where cleaning fluid 139 is to be stored. Outside of the bladder, the vessel may be pre-pressurized with air at the target pressure. As such, pump 901 may fill accumulator 902 with cleaning fluid 139 at the target pressure (e.g., even if less than the target flow rate), for example, before cleaning shuttle 130 will be used to wash robotic cleaner 300 and/or cleaning pad 307 thereof. For example, the target pressure may be 100-300 psi, 10-30 psi, and/or the like. As such, pump 901 may be smaller when used in combination with accumulator 902 and value 903, thereby reducing size and cost of pump 901.

Referring now to FIG. 11, FIG. 11 is a schematic diagram of an example pumping system 1100 for cleaning shuttle 130 of docking station 100, according to non-limiting embodiments or aspects of the present disclosure.

In some non-limiting embodiments or aspects, docking station 100 may further include compressor 904 (e.g., an air compressor) fluidly coupled to accumulator 902 and configured to increase pressure within accumulator 902. For example, accumulator 902 may be configured to store cleaning fluid 139 pumped by pump 901 from cleaning fluid tank 104 under pressure. Compressor 904 may be configured to increase the pressure in accumulator 902. Valve 903 may be configured to release cleaning fluid 139 stored under pressure (e.g., in accumulator 902) to spray nozzle 130 (e.g., via at least one internal cleaning fluid conduit 137). As such, spray nozzle(s) 131 may spray cleaning fluid 139 (e.g., onto at least a portion of cleaning surface 307), as described herein.

In some non-limiting embodiments or aspects, pump 901, accumulator 902, valve 903, and compressor 904 may be configured to provide cleaning fluid 139 through spray nozzle(s) 131 at a target pressure (e.g., even if pump 901 on its own and/or pump 901, accumulator 902, and value 903 together may not be powerful enough to pump cleaning fluid 139 at the target pressure and/or target flow rate). For the purpose of illustration, pump 901 may be a pump smaller than would otherwise be required to achieve target pressure and target flow. Accumulator 902 may be vented while being filled with cleaning fluid 139 but pump 901 (e.g., to reduce required pressure to fill accumulator 902). After filling, compressor 903 may pressurize accumulator 902 with air at the target pressure. As such, accumulator 902 may be filled with cleaning fluid 139 at the target pressure, for example, before cleaning shuttle 130 will be used to wash robotic cleaner 300 and/or cleaning pad 307 thereof. For example, the target pressure may be 100-300 psi, 10-30 psi, and/or the like. As such, pump 901 may be smaller when used in combination with accumulator 902, value 903, and compressor 904, thereby reducing size and cost of pump 901.

While the principles of the disclosed subject matter have been described herein, it is to be understood by those skilled in the art that this description is made only by way of example and not as a limitation as to the scope of the disclosed subject matter. Other embodiments are contemplated within the scope of the presently disclosed subject matter in addition to the exemplary embodiments shown and described herein. Modifications and substitutions by one of ordinary skill in the art are considered to be within the scope of the presently disclosed subject matter, which is not to be limited except by the following claims.

What is claimed is:

1. A robotic cleaning system comprising:
a robotic cleaner comprising:
a housing; and
at least one wet cleaning element comprising at least one cleaning surface on an underside of the housing; and
a docking station comprising:
a base;
a support extending laterally from the base, the support configured to receive at least a portion of the robotic cleaner on top of the support, the support defining a cavity; and
at least one cleaning shuttle within the cavity and comprising at least one spray nozzle and at least one mechanical contacting element, the at least one spray nozzle configured to spray cleaning fluid onto at least a first portion of the at least one cleaning surface, the at least one mechanical contacting element configured to contact at least a second portion of the at least one cleaning surface.

2. The robotic cleaning system of claim 1, wherein the at least one cleaning shuttle is configured to move in at least one direction relative to the at least one cleaning surface while the at least one spray nozzle is spraying the cleaning fluid and the at least one mechanical contacting element is in contact with the at least one cleaning surface.

3. The robotic cleaning system of claim 2, wherein the first portion of the at least one cleaning surface comprises a first strip of the at least one cleaning surface comprising a first length equal to a length of the at least one cleaning surface and a first width that is less than a width of the at least one cleaning surface,
wherein the second portion of the at least one cleaning surface comprises a second strip of the at least one cleaning surface comprising a second length equal to a length of the at least one cleaning surface and a second width that is less than a width of the at least one cleaning surface, and
wherein, upon movement of the at least one cleaning shuttle in the at least one direction relative to the at least one cleaning surface, the at least one spray nozzle sprays the cleaning fluid on substantially an entire surface of the at least one cleaning surface and the at least one mechanical contacting element scrapes substantially the entire surface of the at least one cleaning surface.

4. The robotic cleaning system of claim 1, wherein the at least one spray nozzle comprises two spray nozzles.

5. The robotic cleaning system of claim 1, wherein the at least one spray nozzle comprises at least one of a fan nozzle, a deflector nozzle, or any combination thereof.

6. The robotic cleaning system of claim 1, wherein the at least one spray nozzle is configured to spray the cleaning fluid at a pressure of 100-300 pounds per square inch.

7. The robotic cleaning system of claim 1, wherein the at least one spray nozzle is configured to spray the cleaning fluid at a pressure of 10-30 pounds per square inch.

8. The robotic cleaning system of claim 1, wherein the first portion of the at least one cleaning surface comprises a strip of the at least one cleaning surface comprising a first length equal to a length of the at least one cleaning surface and a first width that is less than a width of the at least one cleaning surface.

9. The robotic cleaning system of claim 1, wherein the at least one mechanical contacting element comprises at least one of a vertical bar, a plurality of bristles, or any combination thereof.

10. The robotic cleaning system of claim 9, wherein the at least one mechanical contacting element comprises a first vertical bar and a first plurality of bristles on a first side of the at least one spray nozzle and a second vertical bar and a second plurality of bristles on a second side of the at least one spray nozzle opposite the first side.

11. The robotic cleaning system of claim 1, wherein the second portion of the at least one cleaning surface comprises a strip of the at least one cleaning surface comprising a first length equal to a length of the at least one cleaning surface and a first width that is less than a width of the at least one cleaning surface.

12. The robotic cleaning system of claim 1, wherein the at least one wet cleaning element comprises a plate detachably connected to the underside of the housing, and wherein the at least one cleaning surface comprises a mop pad on an underside of the plate.

13. The robotic cleaning system of claim 1, wherein the docking station further comprises:
a cleaning fluid tank configured to store the cleaning fluid; and
a pump configured to pump the cleaning fluid from the cleaning fluid tank to the at least one spray nozzle via at least one internal cleaning fluid conduit.

14. The robotic cleaning system of claim 13, wherein the docking station further comprises:
an accumulator fluidly coupled to the pump and configured to store the cleaning fluid under pressure; and
a valve configured to release the cleaning fluid stored under pressure in the accumulator to the at least one spray nozzle via at least one internal cleaning fluid conduit.

15. The robotic cleaning system of claim 14, wherein the docking station further comprises:
an air compressor fluidly coupled to the accumulator and configured to increase pressure within the accumulator.

16. A docking station for a robotic cleaner, comprising:
a base;
a support extending laterally from the base, the support configured to receive at least a portion of a robotic cleaner on top of the support, the support defining a cavity; and
at least one cleaning shuttle within the cavity and comprising at least one spray nozzle and at least one mechanical contacting element, the at least one spray nozzle configured to spray cleaning fluid onto at least a first portion of at least one cleaning surface of at least one wet cleaning element on an underside of the robotic cleaner, the at least one mechanical contacting element configured to contact at least a second portion of the at least one cleaning surface.

17. The docking station of claim 16, wherein the at least one cleaning shuttle is configured to move in at least one direction relative to the at least one cleaning surface while the at least one spray nozzle is spraying the cleaning fluid and the at least one mechanical contacting element is in contact with the at least one cleaning surface.

18. The docking station of claim 17, wherein the first portion of the at least one cleaning surface comprises a first strip of the at least one cleaning surface comprising a first length equal to a length of the at least one cleaning surface and a first width that is less than a width of the at least one cleaning surface,
wherein the second portion of the at least one cleaning surface comprises a second strip of the at least one cleaning surface comprising a second length equal to a length of the at least one cleaning surface and a second width that is less than a width of the at least one cleaning surface, and
wherein, upon movement of the at least one cleaning shuttle in the at least one direction relative to the at least one cleaning surface, the at least one spray nozzle sprays the cleaning fluid on substantially an entire surface of the at least one cleaning surface and the at least one mechanical contacting element scrapes substantially the entire surface of the at least one cleaning surface.

19. The docking station of claim 16, wherein the at least one spray nozzle comprises at least one of a fan nozzle, a deflector nozzle, or any combination thereof, and
wherein the at least one mechanical contacting element comprises at least one of a vertical bar, a plurality of bristles, or any combination thereof.

20. A method, comprising:
receiving at least a portion of a robotic cleaner on top of a support extending laterally from a base of a docking station, the support defining a cavity;
moving at least one cleaning shuttle within the cavity in at least one direction relative to at least one cleaning surface of at least one wet cleaning element on an underside of the robotic cleaner, the at least one cleaning shuttle comprising at least one spray nozzle and at least one mechanical contacting element;
while moving the at least one cleaning shuttle, spraying, with the at least one spray nozzle, cleaning fluid onto at least a first portion of the at least one cleaning surface; and
while moving the at least one cleaning shuttle, contacting, with the at least one mechanical contacting element, at least a second portion of the at least one cleaning surface.
